(19) United States
(12) Patent Application Publication
(10) Pub. No.: US 2007/0175722 A1
(43) Pub. Date: Aug. 2, 2007

(54) Clamping body freewheel

(76) Inventor: Frank Straub, Hohenroth (DE)

Correspondence Address: HEDMAN & COSTIGAN P.C., 1185 AVENUE OF THE AMERICAS, NEW YORK, NY, 10036, US

(21) Appl. No.: 11/699,831

(22) Filed: Jan. 30, 2007

(30) Foreign Application Priority Data
Feb. 1, 2006 (DE) 10 2006 004 491.6

(51) Int. Cl. F16D 41/06

(52) U.S. Cl. 192/45.1

(57) ABSTRACT

A clamping body freewheel (1) has clamping bodies (2) arranged between a cylindrical outer raceway (4) and a cylindrical inner raceway (3) which is concentric with respect to said cylindrical outer raceway (4), which clamping bodies (2) can be tilted between a freewheel position and a clamping position, and has a cage (6) which guides the clamping bodies (2). The clamping bodies (2) are shaped and guided in the cage (6) in such a manner that they are raised both from the inner raceway (3) and from the outer raceway (4) into the freewheel position when a minimum rotational speed of the cage (6) is exceeded.

### FIELD OF THE INVENTION

The invention relates to a clamping body freewheel, having clamping bodies which are guided in an annular space between a cylindrical inner clutch part and a hollow cylindrical outer clutch part by means of a cage, and can be pivoted between a clamping position, which permits a transmission of torque between the clutch parts, and a freewheel position.

### BACKGROUND OF THE INVENTION

A clamping body freewheel according to the preamble of Claim 1 is known, for example, from DE 103 10 225 A1. As the outer ring of said known clamping body freewheel rotates, the clamping bodies introduce centrifugal forces into the outer ring. The cage of the freewheel has the function inter alia of transmitting forces from the clamping bodies into the outer ring and has delimiting walls within pockets provided for holding clamping bodies, which delimiting walls allow the clamping bodies to be supported against the cage. When the centrifugal force reaches a sufficient level, the clamping bodies are raised in a desired way from the inner raceway, so that the outer clutch part, and with the latter the cage and the clamping bodies, rotate without any friction influences from the inner clutch part.

A clamping body freewheel clutch is known from DE 2 004 457 C, which clamping body freewheel clutch is intended to permit a pivoting movement of the clamping bodies which leads to the clamping bodies being raised from the outer clamping track. In said clamping body freewheel clutch, the clamping bodies remain in contact at all times with the inner ring, that is to say the inner clutch part.

### OBJECT OF THE INVENTION

The invention is based on the object of specifying a clamping body freewheel which is particularly suitable for high relative rotational speeds between the inner and outer clutch parts.

### SUMMARY OF THE INVENTION

Said object is achieved according to the invention by means of a clamping body freewheel having the features of claim 1. Said clamping body freewheel having a cylindrical inner raceway and a cylindrical outer raceway which is concentric with respect to said cylindrical inner raceway has clamping bodies which can be tilted between a freewheel position and a clamping position and are guided in a cage, which clamping bodies are shaped and guided in the cage in such a manner that-they are raised both from the inner raceway and from the outer raceway into the freewheel position as a function of the rotational speed of the cage. Both the friction between the clamping bodies and the outer raceway and the friction between the clamping bodies and the inner raceway is therefore eliminated when a minimum rotational speed of the cage is exceeded. When the rotational speed of the cage falls below the minimum value the clamping bodies automatically return, possibly with hysteresis, into a position of clamping readiness. In order to maintain the clamping readiness for as long as the minimum rotational speed of the cage is not exceeded, each clamping body is preferably spring-mounted on the cage by means of a separate spring. The springs, which are preferably embodied as coil springs, extend for example in the radial direction of the clutch parts. It is also alternatively possible, for example, for all the clamping bodies of the freewheel to be acted on with a force in the direction of the clamping position by means of one single spring strip.

In a preferred embodiment, the clamping body freewheel has only one single cage, composed in particular of a polymer material. If the cage is produced from a metallic material, non-cutting shaping processes are preferable. Regardless of the material from which the cage is produced, said cage has pockets which hold the clamping bodies. Said pockets are preferably delimited by guide tracks which interact with surface sections of the clamping bodies, have a curved shape and thereby permit a defined pivoting movement of the clamping bodies. In a particularly advantageous embodiment, each clamping body is pivotable exclusively about one centre of rotation which is positionally fixed relative to the cage. In contrast to the centre of rotation, the centre of gravity of a clamping body is not positionally fixed relative to the cage. The centre of gravity of a clamping body is preferably spaced apart from the inner raceway, and therefore from the axis of the clamping body freewheel, to a lesser extent than the centre of rotation of the clamping body at least when the clamping body is in its clamping position.

In a preferred embodiment, the clamping body has two curved peripheral sections which are connected to one another by two preferably straight intermediate pieces. Each of the curved peripheral sections interacts with a raceway of the clamping body freewheel and with a guide track formed by the cage. It is preferable for at least that part of the curved peripheral section which bears against one of the raceways to describe a logarithmic spiral. A constant clamping angle is therefore provided regardless of the angular position of the clamping body. The intermediate sections of the clamping body, which are not curved or are less curved than the peripheral sections which bear against the raceways, preferably serve as a bearing face for a spring which is braced between the cage and the clamping body and which ensures the constant clamping readiness of the clamping body freewheel as long as the clamping body is not raised from the raceways by the centrifugal force acting on it.

According to a preferred refinement, the clamping body freewheel also has rolling bodies for providing radial bearing properties. Here, in the same axial region in which the clamping bodies are also arranged, rolling bodies are arranged between adjacent clamping bodies in the peripheral direction, with the total number of clamping bodies in the freewheel clutch preferably corresponding to the total number of rolling bodies provided for mounting the inner clutch part relative to the outer clutch part in the manner of a radial bearing. The rolling bodies, for example balls or cylindrical rollers, are preferably guided in the same cage which is also provided for guiding the clamping bodies. As long as the clamping bodies are in contact with the inner ring and the outer ring, they slide on both raceways. If the clamping bodies are raised from both raceways as a result of the centrifugal forces acting on them, then although they continue to rotate—with the cage—at an angular speed between the angular speed of the inner ring and the angular speed of the outer ring, the sliding friction between the clamping bodies and the raceways is eliminated.

An exemplary embodiment of the invention is explained in more detail in the following on the basis of a drawing, in which:

### BRIEF DESCRIPTION OF THE DRAWING

FIG. 1 shows a clamping body freewheel with clamping bodies in different positions,

FIG. 2 shows the clamping body freewheel from FIG. 1 in the freewheel position, and

FIG. 3 shows the clamping body freewheel from FIG. 1 in the clamping position.

### DETAILED DESCRIPTION OF THE DRAWING

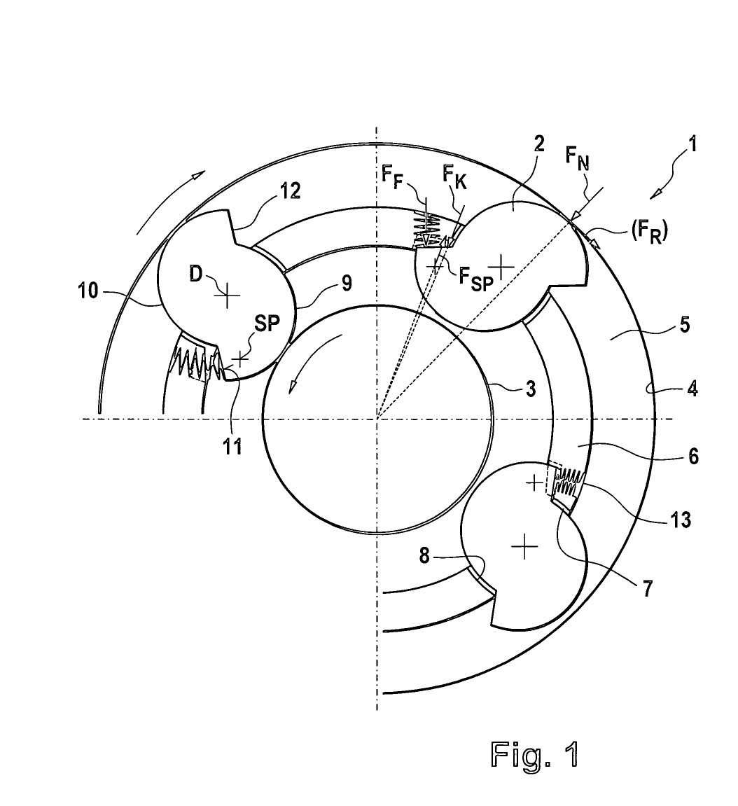

FIG. 1 illustrates, in sections, a clamping body freewheel 1 whose clamping bodies 2, unlike in real operation, are in different angular positions: the clamping body 2 arranged top left in the illustration is in the clamping position, while the clamping body 2 arranged bottom right is in the freewheel position. The clamping body 2 arranged in between is illustrated in an intermediate position. The clamping body 2 in the clamping position is in contact both with an inner raceway 3 and with an outer raceway 4 of the clamping body freewheel 1. The cylindrical inner raceway 3 is the surface of a shaft or hollow shaft which is also referred to as the inner clutch part. Similarly, the outer raceway 4 is a cylindrical surface of an outer clutch part. The clamping bodies 2 are guided in the annular space 5 formed between the raceways 3 and 4 by means of one single cage 6. For this purpose, the cage 6 has pockets 7 which each hold a clamping body 2 and are delimited by guide tracks 8 which are curved in the illustrated cross section.

A clamping body 2 has the following four peripheral sections in the illustrated cross section: a first curved peripheral section 9 bears against the inner raceway 3; a second curved peripheral section 10 bears against the outer raceway 4. Each of said curved peripheral sections 9, 10 describes a logarithmic spiral at least in that region in which the clamping body 2 comes into contact with a raceway 3, 4. The profile of the clamping body 2 is completed by two intermediate sections 11, 12 which connect the curved peripheral sections 9, 10, with the first intermediate section 11 being situated radially within the cage 6 and the second intermediate section 12 being situated radially outside the cage 6. A spring 13 embodied as a pressure spring, specifically a coil spring, is braced between the first intermediate section 11, which is not curved, and the cage 6. Said spring 13 acts permanently on the clamping body 2 with a force FF in the direction of the clamping position. In a corresponding way, a second spring which performs the same function can be braced between the second intermediate section 12 and the cage 6.

If the cage 6 is not rotated or rotates only slowly, the clamping body 2 is in permanent clamping readiness. The clamping body freewheel 1 rotates freely when the outer raceway 4 rotates clockwise while the inner raceway 3 does not rotate. The same applies when the outer raceway 4 is stationary and the inner raceway 3 rotates counter-clockwise. The relative movement of the raceways 3, 4 in said freewheel state is indicated in FIG. 1 by arrows.

During freewheel operation, the cage 6 can remain stationary. In the following, however, it is assumed that the cage 6 rotates, with the angular speed of the cage 6 deviating from the angular speed of the outer raceway 4. Here, the following forces act on the clamping body 2: a normal force FN which acts in the radial direction from the outer raceway 4 on the clamping body 2, a friction force FR which acts between the outer raceway 4 and the clamping body 2 in the tangential direction, a cage force FK with which the cage 6 supports the clamping body 2 in the radial direction, a centrifugal force Fsp which acts at the centre of gravity SP of the clamping body 2, and the previously mentioned spring force FF. In FIG. 1, the centre of gravity SP is illustrated eccentrically within the cross section of the clamping body 2 in an exaggerated fashion. This is intended to clarify that the centre of gravity SP is spaced apart from the centre of rotation D about which the clamping body 2 can pivot. The position of the centre of rotation D is invariable relative to the cage 6. As the centrifugal force Fsp increases, the spring 13 is compressed, so that when a minimum rotational speed of the cage is exceeded, the clamping body 2 is raised from both raceways 3, 4. The clamping body 2 remains in this angular position for as long as the cage 6 rotates at a sufficient angular speed. If the rotational speed of the cage 6 falls below the minimum value, the spring force FF causes the clamping body 2 to pivot back into a position of clamping readiness.

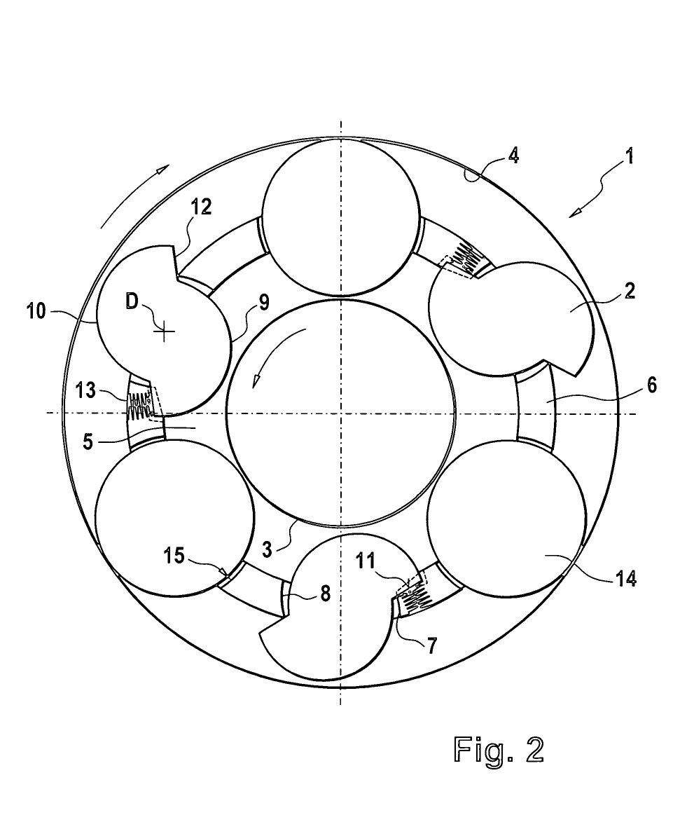

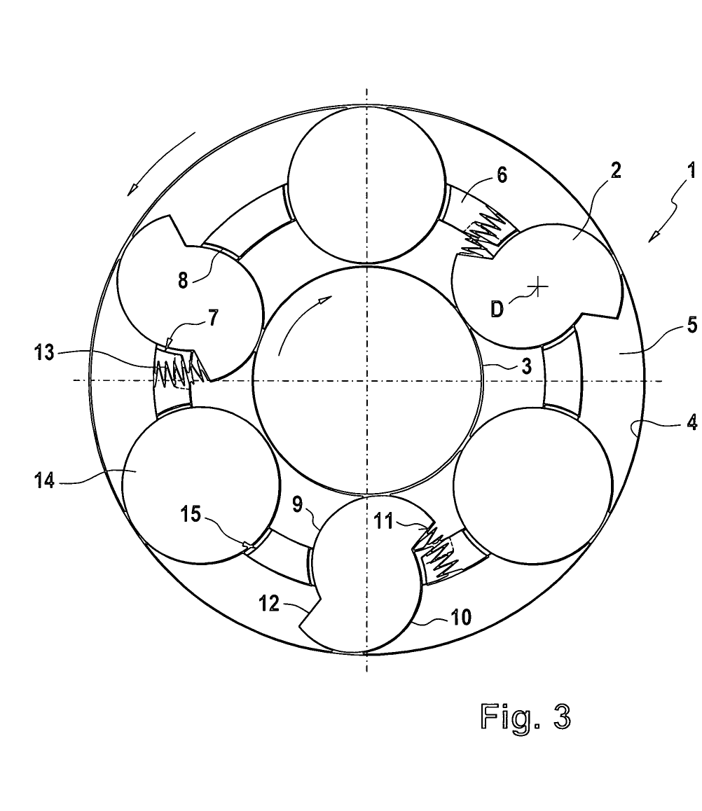

FIGS. 2 and 3 show an embodiment of the clamping body freewheel 1 with rolling bodies 14 which are provided to transmit radial forces between the outer raceway 4 and the inner raceway 3. The shape of the clamping bodies 2 and their guidance in the cage 6 correspond to the exemplary embodiment from FIG. 1. The rolling bodies 14 ensure that the cage 6 rotates, both in the freewheel state (FIG. 2) and in the torque-transmitting state (FIG. 3), at an angular speed between the angular speed of the outer raceway 4 and the angular speed of the inner raceway 3. In the state in FIG. 2, the rotational speed 6 is greater than the so-called minimum speed, so that all the clamping bodies 2 are spaced apart from both raceways 3, 4. The clamping body freewheel 1 behaves in this state as a radial rolling bearing. Here, it is possible both for the inner raceway 3 to rotate when the outer raceway 4 is stationary and for the outer raceway 4 to rotate when the inner raceway 3 is stationary. Despite high speed differences between the outer raceway 4 and the inner raceway 3, the clamping bodies 2 are not subjected to any wear as a result of being in their fully-raised state.

In the state in FIG. 3, a torque acts as indicated by arrows between the raceways 3, 4 in such a way that the clamping bodies 2 assume their clamping position. Here, the function of the clamping body freewheel 1 corresponds in principle to the function of the freewheel known from EP 0 806 584 A1. In contrast to said freewheel, however, only one single cage 6 is provided. In addition to the pockets 7 which guide the clamping bodies 2, the cage 6 has pockets 15 in which in each case one rolling body 14, in particular a cylindrical roller, is held. The clamping body freewheel 1 with radial bearing properties as per FIGS. 2 and 3 is suitable, for example, for a belt drive with a freewheeling function. As a result of the radial bearing integrated into the clamping body freewheel 1, the clamping body freewheel 1 requires a particularly small amount of axial installation space.

### List of Reference Symbols

| | |
|---|---|
| 1 | Clamping body freewheel |
| 2 | Clamping body |
| 3 | Inner raceway |
| 4 | Outer raceway |
| 5 | Annular space |
| 6 | Cage |
| 7 | Pocket |
| 8 | Guide track |
| 9 | First peripheral section |
| 10 | Second peripheral section |
| 11 | Intermediate section |
| 12 | Intermediate section |
| 13 | Spring |
| 14 | Rolling body |
| 15 | Pocket |
| D | Centre of rotation |
| F_{F} | Spring force |
| F_{K} | Cage force |
| F_{N} | Normal force |
| F_{R} | Friction force |
| F_{SP} | Centrifugal force |
| SP | Centre of gravity |

1. Clamping body freewheel, having clamping bodies (2) arranged between a cylindrical outer raceway (4) and a cylindrical inner raceway (3) which is concentric with respect to said cylindrical outer raceway (4), which clamping bodies (2) can be tilted between a freewheel position and a clamping position, and having a cage (6) which guides the clamping bodies (2), characterized in that the clamping bodies (2) are shaped and guided in the cage (6) in such a manner that they are raised both from the inner raceway (3) and from the outer raceway (4) into the freewheel position when a minimum rotational speed of the cage (6) is exceeded.

2. Clamping body freewheel according to claim 1, characterized in that each clamping body (2) is spring-mounted on the cage (6) by means of a separate spring (13).

3. Clamping body freewheel according to claim 2, characterized in that the spring (13) is embodied as a coil spring.

4. Clamping body freewheel according to claim 3, characterized in that the spring (13) extends substantially in the radial direction relative to the cylindrical raceways (3, 4).

5. Clamping body freewheel according to one of claims 1 to 4, characterized in that the cage (6) has curved guide tracks (8), said curved guide tracks (8) delimiting pockets (7) which hold the clamping bodies (2) and permitting pivoting movements of the clamping bodies (2).

6. Clamping body freewheel according to one of claims 1 to 5, characterized in that each clamping body (2) is pivotable exclusively about one centre of rotation (D) which is positionally fixed relative to the cage (6).

7. Clamping body freewheel according to claim 6, characterized in that, when a clamping body (2) is in the clamping position, its centre of gravity (SP) is spaced apart from the inner raceway (3) to a lesser extent than the centre of rotation (D).

8. Clamping body freewheel according to one of claims 1 to 7, characterized in that the clamping body (2) has two curved peripheral sections (9, 10) which interact respectively with the inner raceway (3) and with the outer raceway (4) and are connected to one another by two intermediate sections (11, 12).

9. Clamping body freewheel according to claim 8, characterized in that at least one of the curved peripheral sections (9, 10) has the shape of a logarithmic spiral.

10. Clamping body freewheel according to claim 8 or 9, characterized in that at least one of the intermediate sections (11, 12) is not curved.

11. Clamping body freewheel according to one of claims 8 to 10, characterized in that a spring (13) which acts on the clamping bodies (2) with a force in the direction of the clamping position is braced between the cage (6) and one of the intermediate sections (11, 12) of the clamping body (2).

12. Clamping body freewheel according to one of claims 1 to 11, characterized in that a rolling body (14) is arranged between the raceways (3, 4) between successive clamping bodies (2) in the peripheral direction.

13. Clamping body freewheel according to claim 12, characterized in that the rolling bodies (14) are guided in the same cage (6) which is also provided for guiding the clamping bodies (2).
